(19) United States
(12) Patent Application Publication
(10) Pub. No.: US 2015/0013790 A1
(43) Pub. Date: Jan. 15, 2015

(54) AXIAL FLUID VALVES

(71) Applicant: Fisher Controls International LLC, Marshalltown, IA (US)

(72) Inventors: Elliot James Hoff, Ames, IA (US); Ross Arthur Schade, Ames, IA (US); Andrea Leigh Kenney, Iowa City, IA (US); Bradley Steve Tibben, Nevada, IA (US)

(21) Appl. No.: 13/942,118

(22) Filed: Jul. 15, 2013

(51) Int. Cl. F16K 5/04; F16K 31/60; F16K 37/00

(52) U.S. Cl. CPC F16K 5/0407; F16K 37/00; F16K 5/0442; F16K 31/60
USPC 137/553; 251/213; 251/324; 251/264

(57) ABSTRACT

Axial fluid valves having curved or angled valve bodies are described herein. An example apparatus disclosed herein includes a valve body defining a passageway between an inlet and an outlet, the inlet is aligned along a first axis and the outlet is aligned along a second axis. The example apparatus includes a flow control member interposed between the inlet and the outlet. The example apparatus also includes an actuator having a stem coupled to the flow control member to move the flow control member along a third axis in the passageway. In the example apparatus, the third axis is substantially parallel to and offset from at least one of the first axis or the second axis.

### FIELD OF THE DISCLOSURE

The present disclosure relates generally to axial fluid valves and, more specifically, to axial fluid valves having curved or angled valve bodies.

### BACKGROUND

Fluid control valves (e.g., sliding stem valves, globe valves, rotary valves, butterfly valves, ball valves, etc.) are used in process control systems to control the flow of process fluids and typically include an actuator (e.g., rotary actuator, linear actuator, etc.) to automate operation of the valve. Some of these fluid control valves, although effective in many applications, involve tradeoffs. For example, butterfly valves may be used to control large flow volumes in an efficient manner, but are only capable of modest accuracy, and the seals therein are often limited in life cycle and temperature range. Globe valves, on the other hand, typically provide extremely rigid trim and precise control, but often provide lower flow capacity for a given line size.

In line or axial fluid control valves are an alternative to the above-mentioned fluid control valves. One benefit of axial valves is that they incorporate globe valve style trim and, thus, the advantages offered thereby. Additionally, in axial valves, this trim may be oriented relative to the fluid flow path to increase efficiency and reduce energy losses due to noise and turbulence. Some known axial valves include an actuator mounted to an exterior surface of the valve body and positioned so the output shaft (e.g., stem, spindle, etc.) of the actuator, or a portion thereof, is oriented substantially perpendicular to the fluid flow path of the valve. The output shaft of the actuator is commonly connected to a flow control member (e.g., a plug) within the valve body via a transmission or other actuation conversion components such as, for example, a rack-on-rack assembly, a rack-and-pinion assembly or similar gear assembly. The actuator moves the flow control member within the valve body relative to a seat ring (e.g., a valve seat) between an open position and a closed position to allow or prevent the flow of fluid through the valve. Therefore, many known axial fluid valves exhibit problems with actuation and sealing (e.g., gaskets, packing, seal rings) because these known axial fluid valves often utilize actuators and transmissions within the fluid flow path and, as a result, require a large number of seals and gaskets to protect the gears and other actuation components from pressurized process fluid.

Additionally, in these known axial fluid valves, a bore or channel is often formed in the valve body to allow the actuation components to connect to the flow control member within the fluid flow path. Therefore, the fluid flow path is diverted around the bore or channel that houses the actuation conversion components. These diversions and obstructions in the fluid flow path create turbulence and, as a result, decrease the flow efficiency of the valve. Further, operating axial fluid valves with such a large number of moving parts requiring numerous seals greatly increases the possibility of leakage of fluid outside the valve body and increases manufacturing and maintenance costs.

### SUMMARY

An example apparatus disclosed herein includes a valve body defining a passageway between an inlet and an outlet, the inlet is aligned along a first axis and the outlet is aligned along a second axis. The example apparatus includes a flow control member interposed between the inlet and the outlet. The example apparatus also includes an actuator having a stem coupled to the flow control member to move the flow control member along a third axis in the passageway. In the example apparatus, the third axis is substantially parallel to and offset from at least one of the first axis or the second axis.

Another example apparatus disclosed herein includes a valve body defining a passageway between an inlet and an outlet. In the example apparatus, the inlet is adjacent a first portion of the passageway having a first fluid flow path in a first direction and the outlet is adjacent a second portion of the passageway having a second fluid flow path in a second direction substantially the same as the first direction. The example apparatus includes a plug that is movable within a third portion of passageway having a third fluid flow path in a third direction substantially the same as the first direction and the second direction. In the example apparatus, valve body has a first curved or angled portion between the first portion of the passageway and the third portion of the passageway.

Yet another example apparatus disclosed herein includes a valve body having a flow passage including an inlet, an outlet and a flow control aperture. In the example apparatus, a fluid is to flow through the inlet, the outlet and the aperture in substantially the same direction. In the example apparatus, at least a portion of a central axis of the flow passage is non-linear. The example apparatus also includes a flow control member to move along a direction of a fluid flow through the aperture to control the fluid flow through the valve body.

### BRIEF DESCRIPTION OF THE DRAWINGS

FIG. 1A illustrates a cross-sectional view of an example axial fluid control valve in a first (open) position in accordance with the teachings of this disclosure.

FIG. 1B illustrates a cross-sectional view of the example axial fluid control valve of FIG. 1A in a second (closed) position.

FIG. 1C illustrates a partially cross-sectioned view of the example axial fluid control valve of FIGS. 1A and 1B.

FIG. 1D illustrates a partially cross-sectioned view of the example fluid control valve of FIGS. 1A-1C having an offset inlet and outlet.

FIG. 2 illustrates a partially cross-sectioned view of the example axial fluid control valve of FIGS. 1A-C with a position sensor.

FIG. 3 illustrates a partially cross-sectioned view of the example axial fluid control valve of FIGS. 1A-C having a hand wheel operated actuator.

### DETAILED DESCRIPTION

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

The example axial fluid valves described herein reduce valve noise and cavitation, provide a relatively unobstructed passageway to reduce turbulent fluid flow and improve flow capacity, significantly eliminate in-flow actuating components, which require numerous seals and gaskets, significantly eliminate the structures (e.g., channels, bores) that accommodate such components, and increase overall flow efficiency. In general, the example axial fluid valves described herein include a curved or angled valve body that diverts the flow of fluid between the inlet and the outlet to a portion of the valve body containing a flow control member that moves in a direction substantially aligned with the flow of fluid. More specifically, the axial fluid valves described herein enable the use of globe valve style trim (e.g., a plug and seat ring) oriented substantially in line with a portion of the passageway and, thus, the fluid flow path. The valve bodies of the example axial fluid valves define a passageway with less curvature and/or sharp angles than a traditional globe valve or sliding stem valve while still maintaining linear actuation in the direction of the fluid flow path, which reduces turbulence in the valve. The example axial valves provide a more streamlined flow path.

In some examples, the flow control member (e.g., a plug, a valve plug) is operatively coupled to an actuator (e.g., a pneumatic actuator, a hydraulic actuator, an electric actuator) via a valve stem. The valve body is curved or angled in a manner that allows the actuator to move the plug linearly within a portion of the passageway without the use of additional actuation or conversion components. Thus, the shape of the valve body reduces the number of actuation components, outside and inside of the valve, while maintaining a relatively linear and smooth fluid flow path.

More specifically, an example axial fluid valve described herein includes a first valve body portion having an inlet and an outlet and a second valve body portion having and inlet and an outlet. The outlet of the first valve body portion is coupled to the inlet of the second valve body portion. When coupled together, the first and second valve body portions define a passageway between the inlet of the first valve body portion and the outlet of the second valve body portion. A flow control member is slidably received within the first valve body portion near the outlet of the first valve body portion and is to engage a valve seat (e.g., a seat ring) to prevent or allow the flow of fluid through the valve.

In an example valve disclosed herein, the inlet of the first valve body portion is aligned along a first axis and the outlet of the second valve body portion is aligned along a second axis which, in some examples, is substantially aligned with the first axis such that the inlet and the outlet are coaxial. The first valve body portion includes a first curved or angled portion that directs the flow of fluid from the first axis at the inlet to a third axis at the outlet of the first valve body portion adjacent the valve seat. In some examples, the third axis is parallel to and offset from the first and/or second axes. By including the first curved portion, the example valve body enables the actuator to have sufficient space and position to move the flow control member linearly in the passageway with fewer actuation/conversion components than traditional in line axial fluid valves.

In other words, the passageway of example valve directs the flow of fluid through the inlet of the first valve body portion in a first direction along the first axis, through the first curved portion, and then redirects the flow of fluid at the flow control member in a third direction along the third axis. Therefore, the curved portion of the first valve body portion directs the flow of fluid away from the first axis and then redirects the flow of fluid along a direction substantially the same as the first direction along the third axis. In some examples, the second valve body portion receives the process fluid flow from the outlet of the first body portion along the third axis, directs the process fluid through a second curved or angled portion away from the third axis, and then redirects the fluid to a second direction along the second axis at the outlet. In some examples, the first, second and third directions are substantially the same. In other examples, the outlet of the second valve body portion may be aligned along other axes.

In some examples, the axial fluid valve includes a sensor to measure the location of the valve stem in relation to the valve body. The sensor provides a feedback signal to the actuator to communicate the location of the valve stem (and thus the flow control member) more accurately. In some examples, a hand wheel is utilized for manual operation of the valve.

The examples described herein enable the passageway of the fluid flow path to remain relatively smooth and linear while significantly reducing or eliminating actuation components outside and within the fluid flow path, thereby increasing fluid flow efficiency. With fewer actuation components, the example axial fluid valves simplify manufacturing and machining requirements and, thus, decrease the cost of manufacturing an axial fluid valve. Further, the example axial fluid valve described herein reduces leakage caused by seal failures because the actuator(s) may be disposed outside the fluid stream. Furthermore, by having fewer moving parts, the example axial fluid valves described herein greatly reduce the possibility of mechanical failure and leakage during operations.

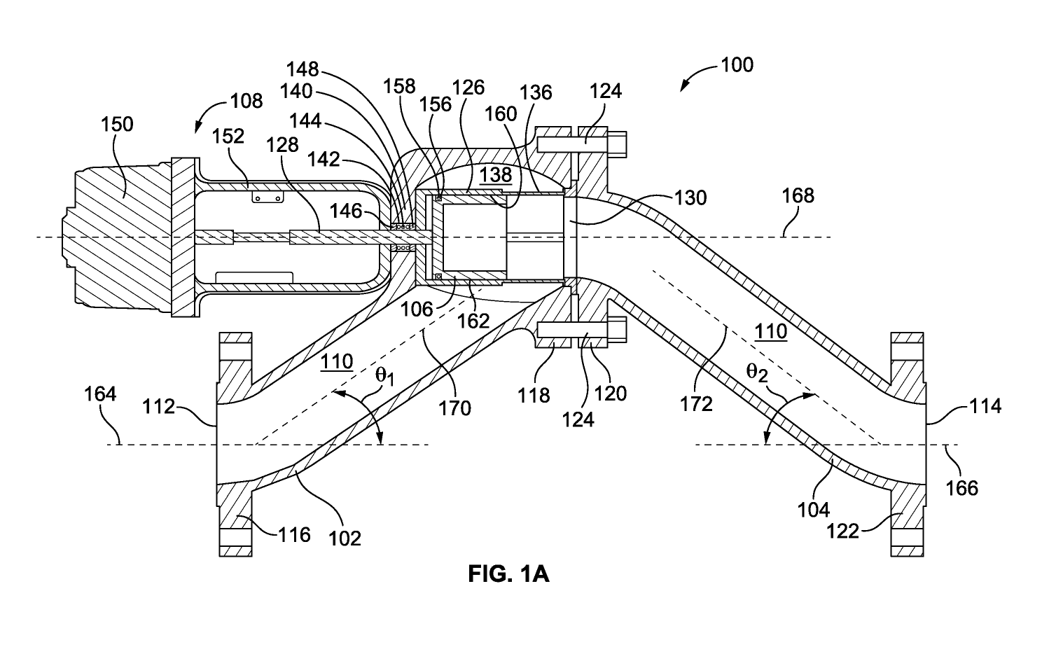

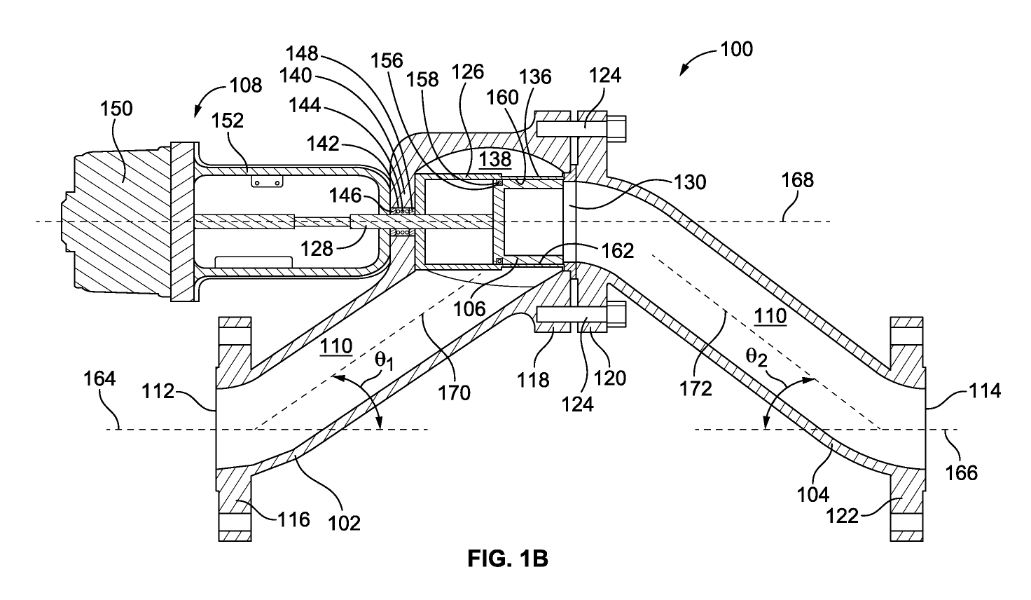

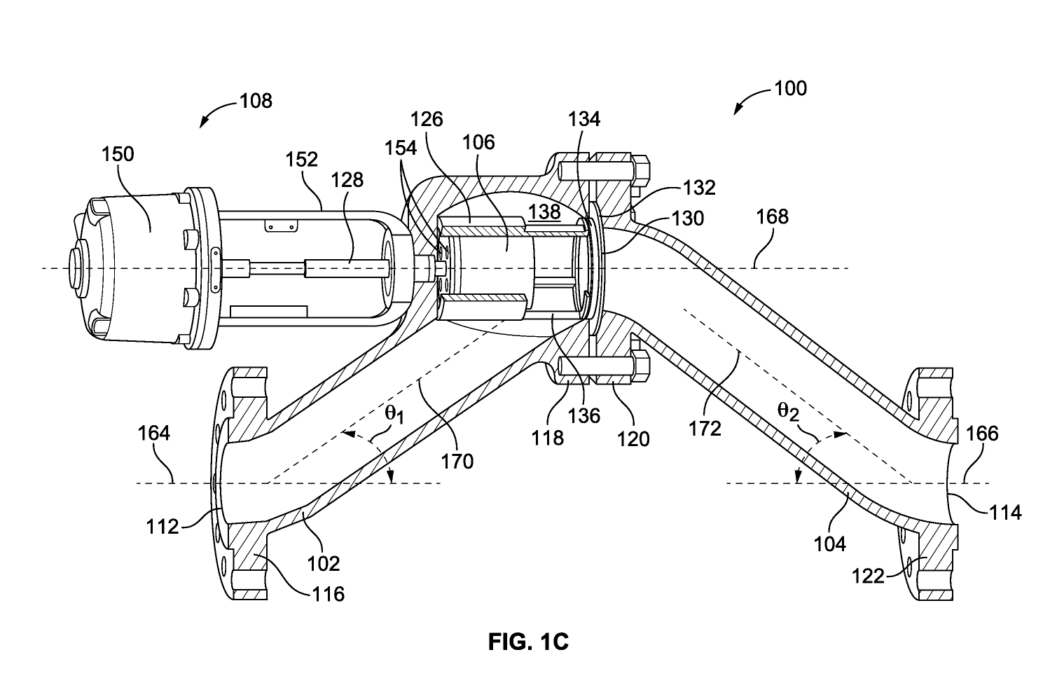

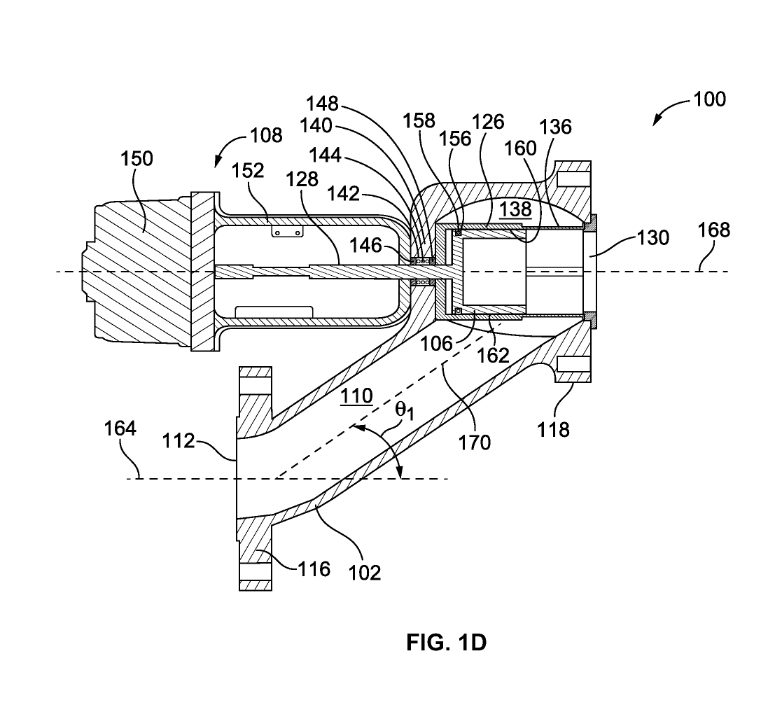

Turning to the figures, FIGS. 1A and 1B illustrate cross-sectional views of an example axial fluid control valve 100 described herein. The valve 100 includes a first valve body portion 102, a second valve body portion 104, a flow control member 106 (e.g., a plug) and an actuator 108. The valve body portions 102 and 104 are coupled to define a passageway 110 that provides a fluid flow path (e.g., a curved flow path, a U-shaped flow path, an angled flow path, etc.) between an inlet 112 and an outlet 114 when the axial fluid control valve 100 is installed in a fluid process system (e.g., a distribution piping system). In some examples, the first valve body portion 102 and the second valve body portion 104 may be integrally formed to define the axial fluid control valve 100 as a substantially unitary piece or structure.

In the example shown, the first valve body portion 102 includes a first flange 116 at the inlet 112 and a second flange 118 removably coupled to a third flange 120 of the second valve body portion 104. In some examples, the portion of the first valve body 102 adjacent the second flange 118 is considered an outlet for the first valve body portion 102 and the portion of the second valve body portion 104 adjacent the third flange 120 is considered in inlet for the second valve body portion 104. The second valve body portion 104 also includes a fourth flange 122 at the outlet 114. The second flange 118 of the first valve body portion 102 and the third flange 120 of the second valve body portion 104 are coupled via flange fasteners 124 (e.g., bolts). In other examples, the second flange 118 and the third flange 120 may be removably coupled with any other suitable fastening mechanism(s). In operation, the first flange 116 of the first valve body portion 102 may be coupled to an upstream pipe (e.g., an upstream supply source) and the fourth flange 122 of the second valve body portion 104 may be coupled to a downstream pipe (e.g., a downstream supply source). Although the inlet 112 and the outlet 114 are referred to, respectively, as the inlet and the outlet of the valve 100, in other examples, the inlet and the outlet may be reversed, such that the outlet 114 is the inlet of the valve 100 and the inlet 112 is the outlet of the valve 100.

In the example shown in FIG. 1A, the valve 100 is in a first (e.g., open) position and in the example shown in FIG. 1B, the valve 100 is in a second (e.g., closed) position. The valve 100 is to be interposed in a fluid flow path between an upstream supply source and a downstream supply source to control the flow of process fluid, which may include any industrial fluid related applications such as, for example, fossil fuel production, refining, and gas transmission. In operation, the plug 106 operates between the first position to allow the flow of fluid between the inlet 112 and the outlet 114 (FIG. 1A) and the second position to prevent the flow of fluid between the inlet 112 and the outlet 114 (FIG. 1B).

FIG. 1C illustrates a partially cross-sectioned view of the example valve 100. As shown in FIGS. 1A, 1B and 1C, the plug 106 is slidably disposed within a cage 126 and moves between the open position (FIGS. 1A and 1C) and the closed position (FIG. 1B) to control the fluid flow through the valve 100. A stem 128 (e.g., a valve stem, a plug stem) couples the plug 106 to the actuator 108, which operates to move the plug 106 toward and away from a valve seat 130 (e.g., a seat ring, a flow control aperture). The cage 126 is coupled to an inner surface of the first valve body portion 102 and may be attached using any suitable fastening mechanism(s). In some examples, the cage 126 may be clamped or pinched between a section of the first valve body portion 102 and another component of the valve 100.

As shown more clearly in FIG. 1C, the valve seat 130 includes a flange portion 132 and a seat portion 134. In the example shown, the flange portion 132 of the valve seat 130 is coupled (e.g., clamped, pinched) between the first and second valve body portions 102, 104 and, more specifically, between the second flange 118 and the third flange 120. In other examples, the valve seat 130 may be attached to the valve 100 using other suitable attachment devices (e.g., threads, bolts, etc.). In the example shown, the seat portion 134 extends into the passageway 110 such that the plug 106 may engage the seat portion 134 to prevent the flow of fluid through the valve 100, as described further detail below.

In the example shown, the cage 126 includes at least one opening 136 through which fluid can flow when the fluid valve 100 is in the open position (i.e., when the plug 106 is spaced away from the valve seat 130). The cage 126 may be configured in different manners (e.g., the openings 136 having various shapes, sizes or spacing) to provide particular, desirable fluid flow characteristics such as, for example, to control the flow, reduce noise and/or cavitation, to enhance pressure reductions of the process fluid, etc.

In the example shown, the cage 126 is disposed within a cavity 138 formed in the first valve body portion 102. Part of the cavity 138 is defined by a wall section 140 of the first valve body portion 102. In the example shown, the stem 128 extends through an aperture 142 in the wall section 140 of first valve body portion 102. The aperture 142 includes a packing 144 to maintain a seal between the passageway 110 and the outside of the valve 100 and enables a smooth, linear movement of the plug stem 128. The packing 144 is secured by gland nuts or retainers 146, 148, which may compress the packing 144 to form a fluid-tight seal and prevent leakage of process fluid from the passageway 110 to the outside of the valve 100.

In the example shown, the actuator 108 includes a drive mechanism 150 and a mounting/alignment support 152. The support 152 may be coupled to the wall section 140 of the first valve body portion using any suitable mechanical fasteners, adhesives, etc. In the example shown, the actuator 108 is a linear actuator. However, in other examples, the example valve 100 may accommodate different types of actuators such as, for example, rotary actuators. The actuator 108 may be any type of actuator such as, for example, a hydraulic actuator, an electric actuator, a mechanical actuator, an electro-mechanical actuator, a piezoelectroic actuator or any other suitable actuator.

As more clearly shown in FIG. 1C, the plug 106 includes channels or conduits 154 to balance or equalize the forces exerted across the plug 106 by the pressures of the process fluid acting on the plug 106. As a result, a smaller actuating force (e.g., via the actuator 108) may be provided to move the plug 106 between the open and closed positions. In other examples, the plug 130 may contain more or fewer channels to balance the pressure behind the plug 106 in the cage 126. In still other examples, the plug 106 may be any other flow control member such as an unbalanced plug (e.g., a plug having no channels or conduits).

In the example shown, the plug 106 also includes a recessed portion 156 to receive a plug seal assembly 158 (e.g., a seal, a seal and an anti-extrusion ring, etc.). The plug seal assembly 158 engages an inner surface 160 of the cage 126 to prevent fluid from leaking between the cage 126 and an outer surface 162 of the plug 106. In some examples, the plug seal assembly 158 also ensures a relatively smooth and linear translation of the plug 106 within the cage 126.

In the example shown in FIGS. 1A-1C, the passageway 110 at the inlet 112 of the valve 100 adjacent the first flange 116 is aligned (e.g., axially) along a first axis 164, and the passageway 110 at the outlet 114 of the valve 100 adjacent the fourth flange 122 is aligned along a second axis 166. In the example shown, the first axis 164 and the second axis 166 are substantially the same (i.e., the inlet 112 and the outlet 114 are coaxial). In other examples, the first and second axes 164, 166 may be parallel but offset (e.g., distanced or spaced apart from one another, non-coaxial), which may depend on the orientation and location of the upstream supply pipe and the downstream supply pipe. In some examples, the first and/or second axes 164, 166 are substantially horizontal such as, for example, when the upstream and downstream supply pipes are horizontally aligned relative to the ground.

In the example shown, a portion of the passageway 110 adjacent the valve seat 130 is substantially aligned along a third axis 168. The third axis 168 is substantially parallel to and offset from the first and second axes 164, 166. In the example shown, a longitudinal axis of the stem 128 is also aligned along the third axis 168. In some examples, the aperture 142 and/or a longitudinal axis of the cage 126 are also substantially aligned along the third axis 168. In operation, the actuator 108 moves the plug 106, via the stem 128, along the third axis 168 within the passageway 110 of the valve 100. More specifically, the plug 106 is moved in away from the valve seat 130 (FIG. 1A) to allow or increase the flow of fluid through the valve 100 and toward the valve seat 130 (FIG. 1B) to restrict or prevent the flow of fluid through the valve 100. The portion of the passageway 106 adjacent the valve seat is substantially aligned along the third axis 168 and, thus, the direction of fluid flow through this portion is also aligned along the third axis 168.

In the example shown, fluid entering the inlet 112 flows in a first direction substantially aligned along the first axis 164 and fluid exiting at the valve 100 at the outlet 114 flows in a second direction substantially aligned along the second axis 166. In some examples, the first direction and the second direction are substantially the same (e.g., right, east, etc.). In some such examples, the first and second axes 164, 166 may be substantially the same (e.g., coaxial) or parallel to but offset from one another. In some examples, the valve 100 is interposed between an upstream supply pipe and a downstream supply pipe having the same axis and, thus, the first and second axes 164, 166 are substantially the same.

In the example shown, fluid moving through the valve seat 130 between the first and second body portions 102, 104 flows in a third direction substantially aligned along the third axis 168. In some examples, the third direction is the substantially the same as the first and/or second directions (e.g., right, east, etc.). In other words, in some examples, the fluid flow path at the inlet 112 is flowing in the first direction and the fluid flow path at outlet 114 is flowing the second direction substantially the same as the first direction, and the fluid flow path at the valve seat 130 (e.g., where the plug 106 allows or prevents fluid flow) is flowing in the third direction substantially the same as the first and second directions. The example valve 100 diverts the flow of fluid from the first direction at inlet 112 along the first axis 164, to the third direction at the valve seat 130 along the third axis 168 and then to the second direction at the outlet 114 along the second axis 166. Therefore, in some examples, a central axis (e.g., from the inlet 112 to the outlet 114) of the entire flow passage is non-linear.

In the example shown, the wall section 140 to which the actuator 108 is coupled is substantially perpendicular to the third axis 168. However, in other examples, the outside surface of the first valve body portion 102 may not include a perpendicular wall section for mounting the actuator 108. In such examples, the actuator 108 may be coupled to an angled or curved section of the first valve body portion 102.

In the example shown, a first curved or angled portion (e.g., a part, a section, a segment, etc.) of the first valve body portion 102 is curved or angled to direct the fluid flow path along a fourth axis 170 between the first axis 164 at the inlet 112 and the third axis 168 at the valve seat 130 (i.e., the outlet of the first valve body portion 102). In the example shown, the first curved or angled portion of the first valve body portion 102, aligned along the fourth axis 170, is substantially linear. However, in other examples, the first valve body portion 102 may not include a linear portion but may be a continuous curve (e.g., a smooth curve, an S-shaped curve, an arcuate shape). As illustrated, a first angle θ₁ is formed between the first axis 164 and the fourth axis 170. In some examples, the first angle θ₁ may be any angle between 0° and 90°.

In the example shown, a second curved or angled portion of the second valve body portion 104 is curved or angled to direct the fluid flow path along a fifth axis 172 between the third axis 168 at the valve seat 130 (i.e., the inlet of the second valve body portion 104) and the second axis 166 at the outlet 114. In the example shown, the second curved or angled portion of the second valve body portion 106, aligned along the fifth axis 172, is substantially linear. In other examples, the second valve body portion 106 may not include a linear portion but may be a continuous curve (e.g., a smooth curve, an S-shaped curve, etc.). A second angle θ₂ is formed between the fifth axis 172 and the second axis 166. In some examples, the second angle θ₂ may be any angle between 0° and 90°. The first and second angles θ₁ and θ₂ may be substantially the same or different depending on the design parameters or specifications of the fluid processing system. In the example shown, the diameter of the passageway 110 in the second valve body portion 106 is substantially constant. However, in other examples, the diameter of the passageway 110 in the second valve body portion 104 is varied.

In operation, process fluid provided by an upstream supply pipe enters the valve 100 at the inlet 112. Fluid entering the first valve body portion 102 at the inlet 112 (e.g., through a first portion of the passageway 110) flows in the first direction and is substantially aligned along the first axis 164. The flow of fluid changes direction (e.g., formed by the first angle θ₁) and flows along the fourth axis 170 in the first valve body portion 102. As the fluid approaches the cage 126, the plug 106 and the valve seat 130 (e.g., in a third portion of the passageway 110), the first valve body portion 102 curves to change the flow of fluid to the third direction along the third axis 168. When the valve 100 is in the first (open) position, fluid flows through the openings 136 in the cage and through the valve seat 130 between the first and second valve body portions 102, 104. In some examples, the valve seat 130 lies in a plane that is oriented substantially perpendicular to the first, second and/or third axes 164, 166, 168.

After the fluid flows through the valve seat 130, the fluid changes direction (e.g., formed by the second angle θ₂) and flows along the fifth axis 172 in the second valve body portion 104. As the fluid approaches the outlet 114 (e.g., through a second portion of the passageway 110), the fluid flow path curves to change the flow of fluid to the second direction, which is substantially aligned along the second axis 166. In some examples, the third axis 168 is parallel to and offset from the first and/or second axes 164, 166. In some examples, the first, second and/or third directions are substantially the same.

In the example shown, the linear actuator 108 is oriented along the third axis 168 that is substantially parallel to but offset (i.e., non-coaxial) relative to the first and second axes 164, 166. The stem 128 moves the plug 106 linearly along the third axis 168 (e.g., in the third direction). Thus, the trim assembly (e.g., the plug 106 and the valve seat 130) is oriented and moves substantially linearly relative to the portion of the passageway 110 along the third axis 168. This linear orientation and motion improves flow efficiency and reduces valve noise and turbulence. In the example shown, the shape and curve of the first valve body portion 102 enable the actuator 108 to move the stem 128 and the plug 106 linearly along the third axis 168 with few, if any, actuation conversion components (e.g., a transmission, a linkage assembly, etc). The stem 128 may be coupled directly to the drive device 150 of the actuator 108. Therefore, in some examples, only enough space for the stem 128 is needed to operate the plug 106 in the passageway 110. Thus, in some examples, the third axis 168 is only offset from the first and/or second axes 164, 166 by a distance of about half of the diameter of the passageway 110 at the valve seat 130.

In the example shown, the first valve body portion 102, the second valve body portion 104 and/or the flow control member 106 may be made of any suitable material such as, for example, cast iron, carbon steel, corrosion resistant materials such as, for example, stainless steel, high nickel steel, etc., and/or any other suitable material(s), or a combination thereof. In some examples, the valve 100 may not include a second valve body portion 104 such as, for example, when the upstream supply pipe and the downstream supply pipe are offset from one another. In such examples, the inlet 112 is coupled to the upstream supply pipe and the outlet of the first valve body portion (e.g., adjacent the second flange 118) is coupled directly to the downstream supply pipe. The valve seat 130 may be coupled between the second flange 118 and a flange of the downstream supply pipe (or upstream supply pipe if reversed). Also, in some examples, the first, second and/or third axes 164, 166, 168 may be skew (i.e., neither parallel nor intersecting) to one another.

As mentioned above, in some examples, the inlet and the outlet of the valve 100 may be parallel but offset (e.g., distanced or spaced apart from one another, non-coaxial), depending on the orientation and location of an upstream supply pipe and a downstream supply pipe. In some such examples, as illustrated in FIG. 1D (where reference numbers from FIGS. 1A-1C are used to indicate elements that are similar or identical to those of FIGS. 1A-1C), the second valve body portion 104 (FIGS. 1A-1C) may not be utilized at all. As shown in FIG. 1D, the outlet of the valve 100 is at the outlet of the first valve body portion 102 and, thus, is substantially aligned along the third axis 168. In this example, the second flange 118 of the first valve body portion 102 may be coupled directly to a downstream supply pipe. In some examples, the valve seat 130 may be coupled between the second flange 118 of the first valve body portion 102 and a flange of the downstream supply pipe. The first axis 164 and the third axis 168 (e.g., the outlet of the valve 100 in this example) may be offset by any amount to substantially align the valve 100 with the upstream supply pipe and the downstream supply pipe.

In an example operation, fluid enters the first valve body portion 102 at the inlet 112, via an upstream supply pipe, and flows in a first direction substantially aligned along the first axis 164. The flow of fluid changes direction (e.g., formed by the first angle θ₁) and flows along the fourth axis 170 in the first valve body portion 102. As the fluid approaches the cage 126, the plug 106 and the valve seat 130, the first valve body portion 102 curves to change the flow of fluid to a second direction along the third axis 168. When the valve 100 is in the first (open) position, fluid flows through the openings 136 in the cage, through the valve seat 130 and out the valve 100 into a downstream supply pipe. In some examples, the first and second directions may be substantially the same. The example valve 100 shown in FIG. 1D has a reduced face-to-face length and a reduced number of parts.

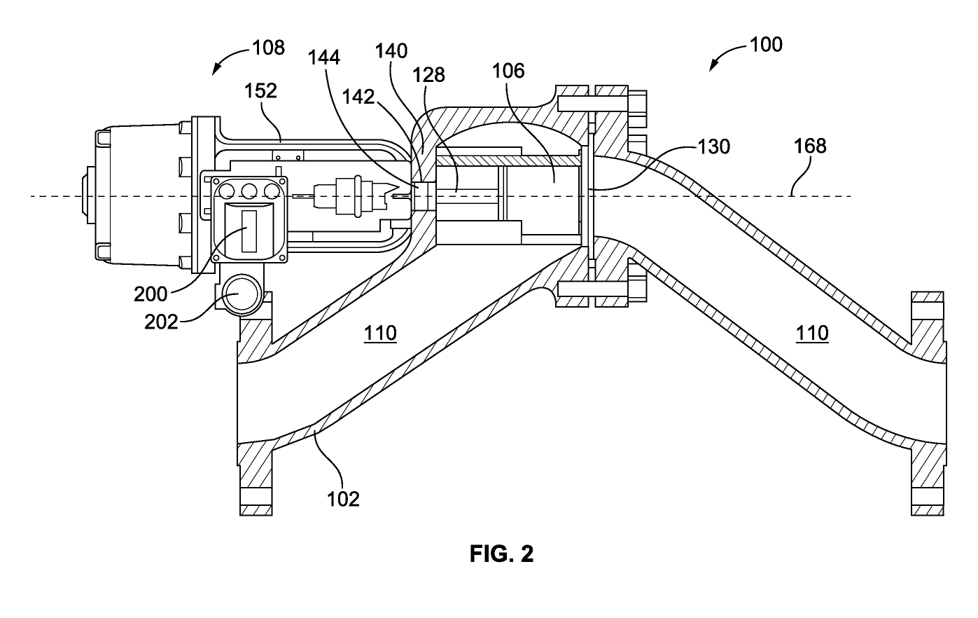

FIG. 2 illustrates a partially cross-sectioned view of the valve 100 with a sensor module 200 for determining the location of the stem 128 and, thus, the flow control member 106 within the passageway 110 of the valve 100. After extensive and repeated use, as commonly seen in known valves, general wear may loosen the sealing interface between the stem 128 and the packing 144 in the aperture 140. Therefore, in some examples, the stem 128 may shift slightly within the aperture 142 in the first valve body portion 102 and become misaligned from the third axis 168. Additionally, in some examples, the interface between the support 152 of the actuator 108 and the wall section 140 of the first valve body portion 102 may loosen and further shift the alignment of the stem 128 with respect to the first valve body portion 102. These shifts may cause the plug 106 to become misaligned relative to the valve seat 130 and the third axis 168 and, as a result, negatively affect operation of the valve 100.

In the example shown, the sensor module 200 is coupled to the first valve body portion 102. A connector 202 maintains the sensor module 200 in a predetermined location with respect to the first valve body portion 102. In this example, the sensor module 200 is to sense the location of the stem 128 and provide a feedback signal to the actuator 108 to more accurately control the location of the flow control member 106 in the valve 100. The feedback signal instantaneously accounts for changes (e.g., play, backlash, slop) in the alignment of the stem 128 and, thus, the plug 106. In some examples, the sensor module 200 includes additional instruments/devices to adjust the position of the stem 128 to account for these changes in the position of the stem 128. In other examples, the sensor module 200 may be coupled to the stem 128 and/or the support 152 to measure the location of the stem 128 relative to the first valve body portion 102.

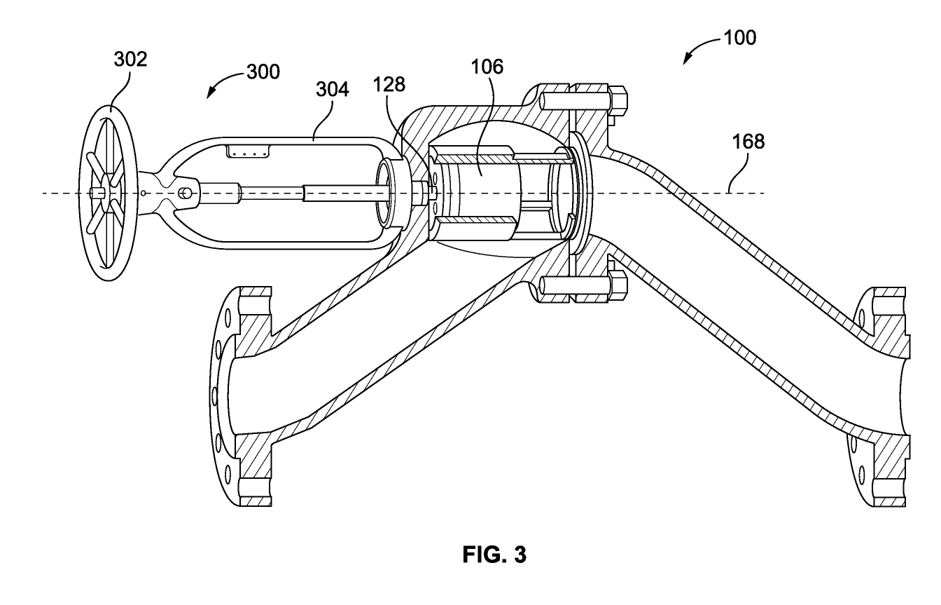

FIG. 3 illustrates a partially cross-sectioned view of the valve 100 with an alternative drive mechanism 300 having a hand wheel 302 and a mounting/alignment support 304. The hand wheel actuator 302 allows an operator or technician to manually operate (e.g., open and close) the valve 100 by rotating the hand wheel 302. In some examples, the drive device 300 includes an assembly of sleeves and threaded rods to move the stem 128 as the hand wheel 302 is rotated. The hand wheel actuator operates 302 operates to move the plug 106 along the third axis 168 to open and close the valve 100.

The example axial fluid control valve 100 described herein advantageously reduces the number of actuating components, which require extensive seals and gaskets, and increases flow efficiency. The example axial fluid control valve 100 also reduces unwanted leakage because the actuation components are disposed outside the pressure boundary of the fluid stream. Additionally, the example axial fluid control valve 100 includes significantly fewer moving parts, which greatly reduce the costs of manufacturing and maintenance and reduces the weight of the valve. The example valve described herein also includes a passageway having minimal curves and turns to provide a less restrictive flow path through the valve.

Although certain example apparatus have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. An apparatus comprising:
a valve body defining a passageway between an inlet and an outlet, the inlet aligned along a first axis and the outlet aligned along a second axis;
a flow control member interposed between the inlet and the outlet; and
an actuator having a stem coupled to the flow control member to move the flow control member along a third axis in the passageway, the third axis being substantially parallel to and offset from at least one of the first axis or the second axis.

2. The apparatus of claim 1, wherein the first axis and the second axis are substantially the same.

3. The apparatus of claim 1 further comprising a valve seat interposed between the inlet and the outlet, wherein a portion of the passageway adjacent the valve seat is aligned with the third axis.

4. The apparatus of claim 3, wherein a plane along which the valve seat is oriented is substantially perpendicular to at least one of the first axis or the second axis.

5. The apparatus of claim 1 further comprising a sensor coupled to the valve body or the stem to determine a location of the stem relative to the valve body.

6. The apparatus of claim 5, wherein the sensor is to communicate the location of the stem to the actuator.

7. The apparatus of claim 1, wherein the valve body comprises an aperture to receive the stem and is substantially aligned along the third axis.

8. The apparatus of claim 1, wherein the stem has a longitudinal axis oriented along the third axis.

9. The apparatus of claim 1, wherein the third axis is spaced apart from the first axis by a distance greater than about a radius of the passageway.

10. An apparatus comprising:
a valve body defining a passageway between an inlet and an outlet, the inlet being adjacent a first portion of the passageway having a first fluid flow path in a first direction, the outlet being adjacent a second portion of the passageway having a second fluid flow path in a second direction substantially the same as the first direction; and
a plug movable within a third portion of passageway having a third fluid flow path in a third direction substantially the same as the first direction and the second direction, wherein the valve body has a first curved or angled portion between the first portion of the passageway and the third portion of the passageway.

11. The apparatus of claim 10 further comprising a hand wheel to manually move the plug within the third portion of the passageway.

12. The apparatus of claim 10 further comprising an actuator having a stem coupled to the plug to move the plug within the third portion of the passageway.

13. The apparatus of claim 12, wherein the actuator is to move the stem in the third direction.

14. The apparatus of claim 12, wherein the actuator is coupled to an outer surface of the valve body.

15. The apparatus of claim 12, wherein the actuator is a linear actuator.

16. The apparatus of claim 10, wherein the valve body further comprises a second curved or angled portion between the third portion of the passageway and the second portion of the passageway.

17. The apparatus of claim 16, wherein the second curved or angled portion of the passageway has a substantially constant diameter.

18. The apparatus of claim 10 further comprising a cage disposed within the third portion of the passageway to receive the plug.

19. The apparatus of claim 18, wherein the cage is coupled to the valve body and has a longitudinal axis substantially aligned with the third direction.

20. An apparatus comprising:
a valve body having a flow passage including an inlet, an outlet and a flow control aperture, wherein a fluid is to flow through the inlet, the outlet and the aperture in substantially the same direction, and wherein at least a portion of a central axis of the flow passage is non-linear; and
a flow control member to move along a direction of a fluid flow through the aperture to control the fluid flow through the valve body.
